(19) United States
(12) Patent Application Publication
(10) Pub. No.: US 2017/0015253 A1
(43) Pub. Date: Jan. 19, 2017

(54) ROOF RAIL DEVICE

(71) Applicant: AISIN SEIKI KABUSHISIKI KAISHA, Kariya-shi (JP)

(72) Inventors: Yasuhiro SHIBATA, Nagoya-shi (JP); Kazumi SUGIYAMA, Toyota-shi (JP)

(73) Assignee: AISIN SEIKI KABUSHISIKI KAISHA, Kariya-shi (JP)

(21) Appl. No.: 15/193,424

(22) Filed: Jun. 27, 2016

(30) Foreign Application Priority Data
Jul. 14, 2015 (JP) 2015-140512

(51) Int. Cl. B60R 9/04; B60R 13/07; B60J 10/36

(52) U.S. Cl. CPC B60R 9/04; B60J 10/36; B60R 13/07

(57) ABSTRACT

A roof rail device includes: a main body member extending along a roof panel of a vehicle; a support member formed in a solid shape and supporting the main body member; a fixing member fixing the main body member and the support member to the roof panel; and a first seal member provided between the support member and the roof panel, wherein the support member includes a through hole, the fixing member is provided with a flange portion, a top side screw portion is formed in a top surface of the flange portion, a bottom side screw portion is formed in a bottom surface of the flange portion, and the top side screw portion is fastened to the main body member, the bottom side screw portion is inserted into the through hole, and the bottom side screw portion is fastened to the roof panel.

### CROSS REFERENCE TO RELATED APPLICATIONS

This application is based on and claims priority under 35 U.S.C. §119 to Japanese Patent Application 2015-140512, filed on Jul. 14, 2015, the entire contents of which are incorporated herein by reference.

### TECHNICAL FIELD

This disclosure relates to a roof rail device of a vehicle.

### BACKGROUND DISCUSSION

For example, as described in JP 2007-55359A (Reference 1), a roof rail device which is attached to a top surface of a roof of a vehicle is known. In the roof rail device of Reference 1, a main body member is fixed to the top surface of the roof of the vehicle via a support member (support legs).

In Reference 1, a fixing member (a bolt) which fixes the support member to the main body member, and a fixing member (a bolt) which fixes the support member to the roof are separate components. In contrast, as illustrated in FIGS. 9 and 10, there is known a fixing member F in which both bolts are integrated, In the example illustrated in FIGS. 9 and 10, a groove portion D which extends in a vehicle front-rear direction (a direction perpendicular to the paper surface in FIG. 10) is formed in a roof RF of the vehicle. A main body member RR is fixed so as to cover the groove portion D.

The main body member RR is formed in a cylindrical shape extending in the vehicle front-rear direction. As illustrated in FIG. 10, a through hole HR which penetrates the wall portion in the vehicle height direction is formed in the wall portion of the bottom side of the main body member RR. A so-called blind nut BN is fitted into the through hole HR. in other words, when a tool for the blind nut BN is inserted into the through hole HR from under the main body member RR and a tip end portion of the tool is screwed into the nut portion of the blind nut BN, a middle portion of the blind nut BN undergoes buckling distortion to protrude outward and is fixed to the main body member RR. Accordingly, the blind nut BN functions in the same manner as an ordinary nut.

A support member LG is formed in a rectangular parallelepiped shape. The support member LG includes a through hole HL which penetrates in the support member LG in the vehicle height direction. A ring-shaped seal member SL is adhered to the outer circumferential portion of the bottom surface of the support member LG.

The fixing member F is formed in a columnar shape extending in the vehicle height direction, and a screw groove is formed in the outer circumferential surface thereof. A fitting portion (for example, a hexagonal hole into which a hexagonal wrench is inserted) which fits into a tool for rotating the fixing member F is formed on the bottom end surface of the fixing member F. A stopper portion ST is formed in a middle portion of the fixing member F in the vehicle height direction. The stopper portion ST is formed in a disc shape. The outer diameter of the stopper portion ST is slightly larger than the outer diameter of the portion in which the screw groove is formed (that is, the outer diameter of the screw portion).

The top end portion of the fixing member F is inserted into the through hole HL from under the support member LG, and the top end portion of the fixing member F is caused to protrude above the top surface of the support member LG. The top end portion of the fixing member F is fastened to the blind nut BN. In this state, the top surface of the stopper portion ST abuts against the bottom surface of the support member LG. In other words, the support member LG is interposed between the main body member RR and the stopper portion ST. In this manner, the support member LG is fixed to the main body member RR.

A through hole HF which penetrates the roof panel in the vehicle height direction is formed in the roof panel which forms the roof RF of the vehicle. The bottom end portion of the fixing member F is inserted into the through hole HF, and a nut NT is fastened to the bottom end portion of the fixing member F from under the roof panel. In this manner, the roof rail device is fixed to the roof RF of the vehicle.

As illustrated in FIG. 11, there is known a roof rail device in which a special nut NX is used instead of the blind nut BN to fix the support member LG to the main body member RR. The nut NX is provided to extend parallel to the longitudinal direction of the main body member RR. The cross section perpendicular to the longitudinal direction of the not NX is trapezoidal. A through hole HN which penetrates the nut NX in the top-bottom direction is formed in the center portion of the nut NX in the longitudinal direction, and the screw groove is formed in the inner circumferential surface thereof. A ring-shaped recessed portion is formed in the bottom surface of the nut NX. The recessed portion is formed to surround the bottom portion of the through hole HN, A seal member SO (an O ring) is fitted into the recessed portion (refer to FIG. 12). The nut NX is inserted into the main body member RR, and a groove portion G which restricts the top-bottom movement and the rotation of the nut NX is formed inside the main body member RR. The nut NX is inserted into the groove portion G inside the main body member RR from one end of the main body member RR.

In the roof rail device of the related art illustrated in FIGS. 9 and 10, a screw portion of the blind nut BN, and a screw portion of the fixing member F are coated with an adhesive which prevents the screw from loosening. Therefore, rainwater or water formed by condensation which enters the main body member RR is prevented from entering the roof along the fitting portion between the screw portion of the blind nut BN and the screw portion of the fixing member F. However, means for preventing water from entering is not provided between the outer circumferential portion of the blind nut BN and the main body member RR (that is, an abutting portion between the through hole HR and the blind nut BN). Means for preventing water from entering is also not provided between a flange portion of the blind nut BN and the support member LG. Therefore, the rainwater or the water formed by condensation which enters the main body member RR passes through a gap of the abutting portion between the through hole HR and the blind nut BN and a gap between the blind nut BN and the support member LG to enter the through hole HL. As illustrated by the dotted line in FIG. 13, the water passes along the surface of the fixing member F and the through hole HL to enter the roof RF. The seal member SL is provided with a function of suppressing the entrance of water (for example, rainwater) adhered to the surface of the roof panel or the surface of the support member LG into the gap between the support member LG and the roof panel, and the flowing of the water along the through hole HF into the roof panel RF (the inside of the vehicle interior). However, the seal member SL is not provided with a function of suppressing the flowing of the water which enters the through hole HL along the surface of the fixing member F and the through hole HL into the roof RF.

Even in the roof rail device of the related art illustrated in FIG. 11, the screw portion of the nut NX and the screw portion of the fixing member F are coated with an adhesive which prevents the screw from loosening. Therefore, the rainwater or the water formed by condensation which enters the main body member RR is suppressed from entering the roof along the fitting portion between the screw portion of the nut NX and the screw portion of the fixing member F. Since the seal member SO is provided on the bottom surface of the nut NX, it is possible to prevent the water from entering the through hole HR from the gap of the abutting portion between the nut NX and the main body member RR. Therefore, the rainwater or the water formed by condensation which enters the main body member RR is suppressed from entering the roof RF. However, since it is necessary to fit the seal member SO into the nut NX, the part costs and manufacturing costs are high. In the process of inserting the nut NX into the main body member RR, the friction between the seal member SO and the main body member RR is great, and the work is difficult.

### SUMMARY

Thus, a need exists for a low cost roof rail device which is not susceptible to the drawback mentioned above. In order to facilitate understanding of this disclosure, description of each component of the following disclosure will be given with symbols of the corresponding parts in the embodiment denoted in parenthesis; however, the components of this disclosure are not be interpreted as being limited to the configuration of the corresponding parts indicated by the symbols of the embodiment.

A feature of an aspect of this disclosure resides in that a roof rail device (10) includes a main body member (11) which extends along a roof panel of a vehicle, a support member (15) which is formed in a solid shape and supports the main body member by being interposed between the main body member and the roof panel, a fixing member (13) which fixes the main body member and the support member to the roof panel, and a first seal member (16) which is provided between the support member and the roof panel and adheres to the support member and the roof panel, in which the support member includes a through hole (HL) which penetrates the support member in a vehicle height direction, in which the fixing member is provided with a flange portion (131) which is perpendicular to the vehicle height direction, in which a top side screw portion (132) which is fastened to the main body member is formed in a top surface of the flange portion, in which a bottom side screw portion (133) which is fastened to the roof panel is formed in a bottom surface of the flange portion, and in which the top side screw portion is fastened to the main body member, the bottom side screw portion is inserted into the through hole of the support member from above the support member, and the bottom side screw portion is fastened to the roof panel in a state in which the flange portion is interposed between the main body member and the support member.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram illustrating an outline of a roof of a vehicle to which a roof rail device according to an embodiment of this disclosure is attached;

FIG. 2 is an exploded perspective diagram of the roof rail device of FIG. 1;

FIG. 3 is a perspective view illustrating a bottom surface of a main body member;

FIG. 4 is a perspective view illustrating a bottom surface of a support member of FIG. 2;

FIG. 5 is a sectional diagram illustrating a section of a fastening portion of the roof rail device, and is a section perpendicular to the vehicle front-rear direction;

FIG. 6 is a sectional diagram illustrating a section of the fastening portion of the roof rail device, and is a section perpendicular to a vehicle width direction;

FIG. 7 is a perspective view of a support member according to a modification example of this disclosure;

FIG. 8 is a perspective view of a support member according to another modification example of this disclosure;

FIG. 9 is an exploded perspective diagram of a roof rail device of the related art;

FIG. 10 is a sectional diagram of a fastening portion of the roof rail device of FIG. 9;

FIG. 11 is a sectional diagram of a fastening portion of a roof rail device according to another example of the roof rail device of the related art;

FIG. 12 is a perspective view for describing the configuration of a bottom surface of a nut of FIG. 11; and

FIG. 13 is a sectional diagram illustrating an entrance path of water.

### DETAILED DESCRIPTION

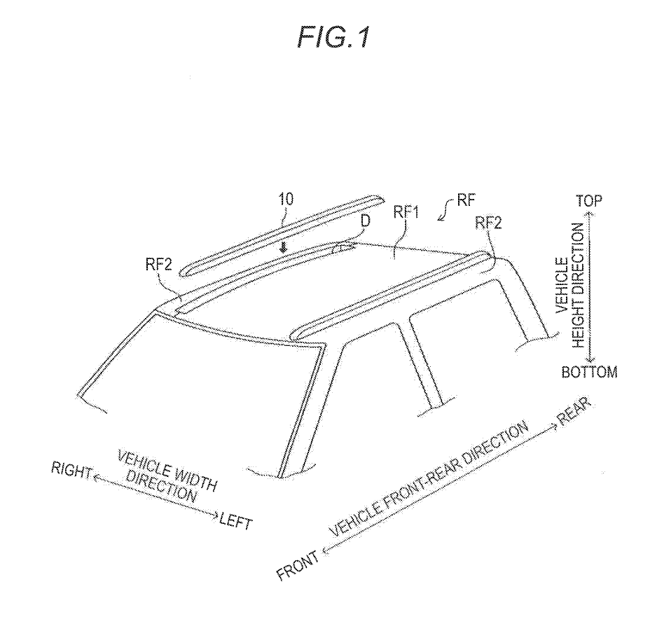

Description will be given of a roof rail device 10 according to an embodiment disclosed here. First, description will be given of the configuration of the roof RF of the vehicle to which the roof rail device 10 is attached. The roof RF is formed by joining a main panel RF1 and a side panel RF2, each of which has a plate form, together (refer to FIGS. 1 and 5). The main panel RF1 and the side panel RF2 correspond to the roof panel. Since the roof RF is formed with a left-right symmetry centered on a center portion in the vehicle width direction, in the following description, only the right side portion of the roof RF will be described, omitting description of the left side portion. The main panel RF1 is formed to cover the center portion of the vehicle interior in the vehicle width direction. The side panel RF2 is formed to cover the right end portion of the vehicle interior. A step-shaped level difference portion RF11 is formed on the right end portion of the main panel RF1. A flange portion RF12 is formed on the bottom end of the level difference portion RF11. The level difference portion RF11 and the flange portion RF12 are provided to extend in the vehicle front-rear direction. The level difference portion RF11 and the flange portion RF12 are formed by bending the right end portion of the main panel RF1. A level difference portion RF21 and a flange portion RF22 similar to the level difference portion RF11 and the flange portion RF12 are formed on the left end portion of the side panel RF2. By welding the flange portion RF12 to the flange portion RF22 in an overlapping state, the groove portion D which extends in the vehicle front-rear direction and is open upward is formed in the top surface of the roof RE The main body member 11 is attached to the groove portion D. The through hole HF is formed in the front end portion, the middle portion, and the rear end portion in the bottom portion of the groove portion D (that is, a portion at which the flange portion RF12 and the flange portion RF22 are overlapping). A bolt-shaped fixing member 13 (described later) is inserted into the through hole HF. The through hole HF of the front end portion is a reference hole, In other words, the inner diameter of the through hole HF of the front end portion is approximately the same as the outer diameter (the screw diameter) of the fixing member 13. The through hole HF of the rear end portion is a long hole which is long in the vehicle front-rear direction. In other words, the width of the through hole HF in the vehicle width direction is approximately the same as the outer diameter (the screw diameter) of the fixing member 13; however, the length of the through hole HF in the vehicle front-rear direction is greater than the outer diameter (the screw diameter) of the fixing member 13. The inner diameter of the through hole HF of the center portion is greater than the outer diameter (the screw diameter) of the fixing member 13.

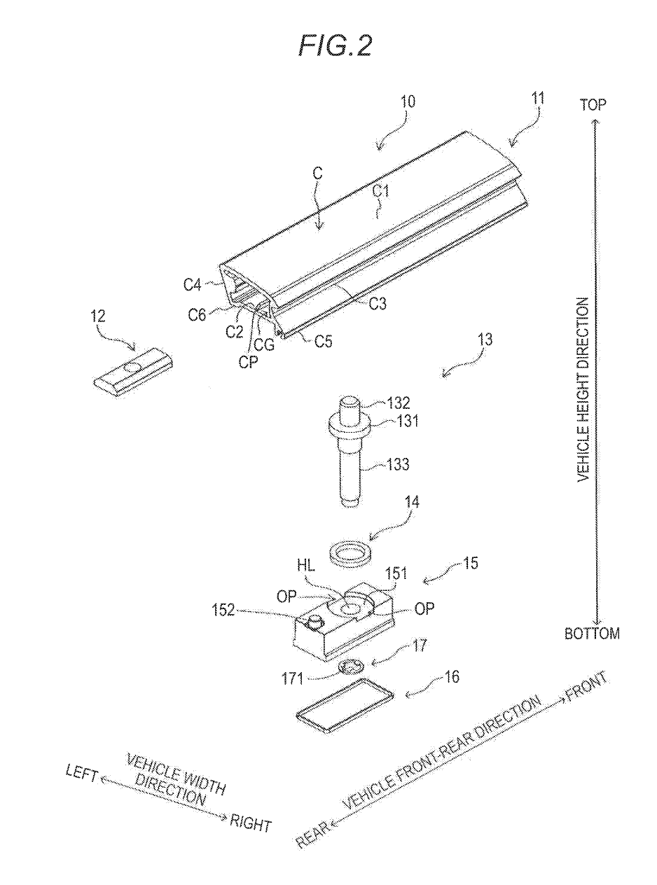

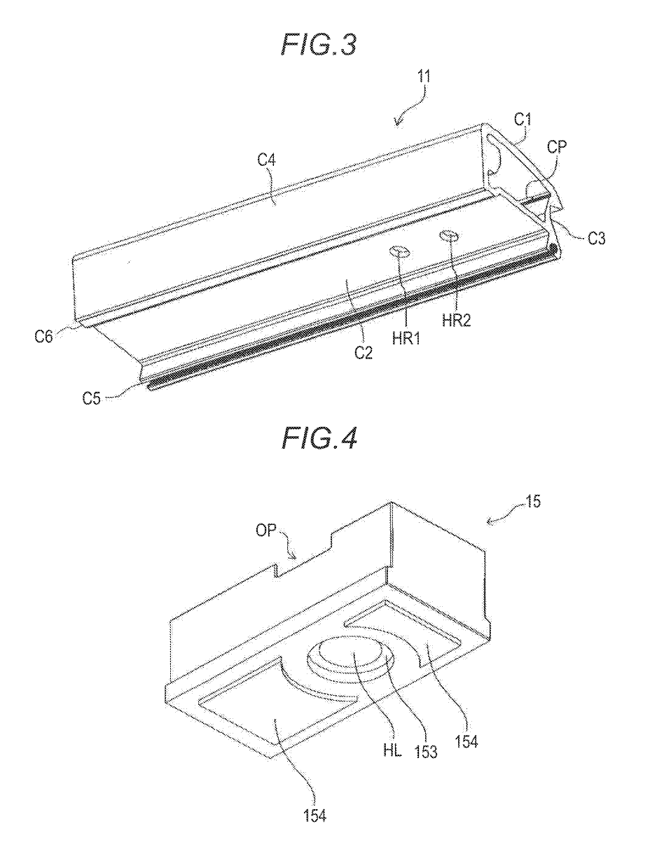

Next, description will be given of the roof rail device 10. As illustrated in FIG. 2, the roof rail device 10 is provided with a main body member 11, a nut 12, a fixing member 13, a second seal member 14, a support member 15, a first seal member 16, and a push nut 17. As illustrated in FIGS. 2 and 3, the main body member 11 includes a main body portion C which is formed in a tubular shape extending in the vehicle front-rear direction. In other words, the main body portion C includes a top wall portion C1 and a bottom wall portion C2 which are formed substantially parallel to the top surface of the roof. A side wall portion C3 is formed between the right end portion of the top wall portion C1 and the right end portion of the bottom wall portion C2, and a side wall portion C4 is formed between the left end portion of the top wall portion C1 and the left end portion of the bottom wall portion C2. A through hole HR1 and a through hole HR2 which penetrate the bottom wall portion C2 in the vehicle height direction are formed in the bottom wall portion C2 (refer to FIG. 3). The through hole HR1 and the through hole HR2 are separated in the vehicle front-rear direction. A ridge portion CP which extends in the vehicle front-rear direction is formed on the center portion of the bottom wall portion C2 in the vehicle width direction. The ridge portion CP is formed in a plate shape which is inclined such that the top end portion is positioned to the right of the bottom end portion. A portion surrounded by the ridge portion CP, the bottom wall portion C2, and the side wall portion C4 is referred to as a groove portion CG. A rail portion C5 which extends in the vehicle front-rear direction is formed on the bottom surface of the right end portion of the bottom wall portion C2. A ridge portion C6 which extends in the vehicle front-rear direction is formed on the bottom surface of the left end portion of the bottom wall portion C2. The main body member 11 is formed by bending an intermediate molding body which is formed by extruding a metal material (for example, an aluminum material) such that the intermediate molding body follows the top surface of the roof RF. The cross-sectional shape of the main body portion C is not limited to that of the embodiment, and may be any shape such as triangular or circular.

A lip member L1 and a lip member L2 are adhered to the rail portion C5 and the ridge portion C6, respectively. The lip member L1 and the lip member L2 are formed of a synthetic rubber, a soft synthetic resin material, or the like, and are formed to extend in the vehicle front-rear direction (refer to FIG. 5). The lip member L1 and the lip member L2 are omitted from FIGS. 2 and 3.

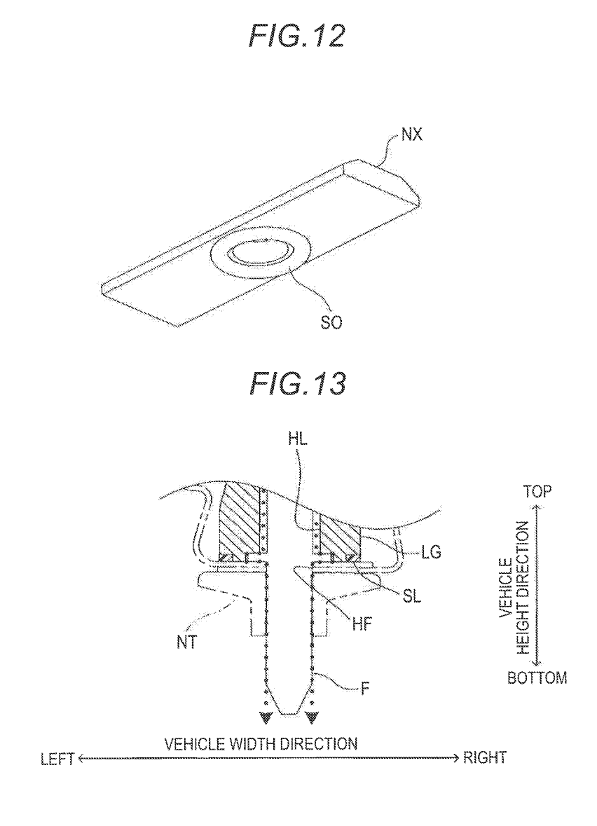

The nut 12 is provided to extend in the longitudinal direction of the main body member 11. The cross section perpendicular to the longitudinal direction of the nut 12 is trapezoidal. The dimension of the top portion of the nut 12 in the vehicle width direction is smaller than the dimension of the bottom portion in the vehicle width direction. A through hole is formed in the center portion of the nut 12 in the longitudinal direction, and a screw groove is formed on the inner circumferential surface of the through hole. Unlike the nut NX of the roof rail device of the related art illustrated in FIG. 12, the bottom surface of the nut 12 is formed in a planar shape, and no seal member is attached to the bottom surface of the nut 12.

The fixing member 13 includes a flange portion 131, a top side screw portion 132, and a bottom side screw portion 133 (refer to FIG. 2). The flange portion 131, the top side screw portion 132, and the bottom side screw portion 133 are formed integrally. The flange portion 131 is formed in a disc shape.

The top side screw portion 132 is a male screw in which a screw groove is formed in the outer circumferential surface of the portion formed in a columnar shape extending upward from the top surface of the flange portion 131. The center axis of the top side screw portion 132 matches the center axis of the flange portion 131. The outer diameter of the top side screw portion 132 is smaller than the outer diameter of the flange portion 131. The bottom side screw portion 133 is a male screw in which a screw groove is formed in the outer circumferential surface of the bottom end portion of the portion formed in a columnar shape extending downward from the bottom surface of the flange portion 131. The center axis of the bottom side screw portion 133 matches the center axis of the flange portion 131. The outer diameter of the bottom side screw portion 133 is the same as the outer diameter of the top side screw portion 132. A hexagonal hole is formed in the center portion of the bottom surface of the bottom side screw portion 133.

The second seal member 14 is formed of a synthetic rubber, a soft synthetic resin material, or the like. The second seal member 14 is formed in a ring shape.

The support member 15 is provided to extend in the vehicle front-rear direction. The support member 15 is a solid member. The support member 15 is formed in a substantially rectangular parallelepiped shape. The through hole HL which extends in the vehicle height direction (a direction perpendicular to the top surface of the roof RF) is formed in a portion of the support member 15 positioned slightly closer to the front than the center portion.

A substantially circular recessed portion 151 is formed in the top surface of the support member 15 (refer to FIG. 2). The recessed portion 151 corresponds to a portion formed by enlarging the inner diameter of the top end portion of the through hole HL to slightly bigger than the middle portion of the through hole HL (a deep counter sinking portion). The inner diameter of the recessed portion 151 is slightly larger than the dimension of the support member 15 in the vehicle width direction. Therefore, the recessed portion 151 includes an opening portion OP which is open to the left and right.

A columnar protruding portion 152 which protrudes upward is formed on the rear end portion of the top surface of the support member 15. The distance between the center axis of the protruding portion 152 and the center axis of the through hole HL matches the distance between the through hole HR1 and the through hole HR2 of the main body member 11.

A ring-shaped recessed portion 153 is formed in the bottom surface of the support member 15 (refer to FIG. 4), The recessed portion 153 corresponds to a portion formed by enlarging the inner diameter of the bottom end portion of the through hole HL to slightly bigger than the middle portion of the through hole HL (a deep counter sinking portion). A protruding portion 154 which protrudes slightly downward is formed in the bottom surface of the support member 15. The protruding portion 154 is a portion formed by causing a portion of the bottom surface of the support member 15 slightly downward excluding the outer circumferential edge portion and the circumferential edge portion of the through hole HL to protrude. The bottom surface of the protruding portion 154 is formed in a planar shape.

The first seal member 16 is adhered to the outer circumferential edge portion of the bottom surface of the support member 15. The first seal member 16 is formed of a synthetic rubber, a soft synthetic resin material, or the like. The first seal member 16 is formed in a ring shape (refer to FIG. 2).

The push nut 17 is formed in a disc shape. The push nut 17 includes a plurality of (for example, three) tab portions 171 which protrude inward.

Next, description will be given of the attachment procedure of the roof rail device 10. First, the nut 12 is inserted into the groove portion CG from one end of the main body member 11. Next, the center axis of the through hole HR1 which is formed in the main body member 11 is caused to match the center axis of the screw portion of the nut 12. For example, a rod-shaped jig is inserted into the through hole HR2 into which the protruding portion 152 is inserted, and the interval between the through hole HR1 and the through hole HR2, and the dimensions of the nut 12 may be set such that the center axis of the through hole HR1 matches the center axis of the screw portion of the nut 12 in a state in which the nut 12 abuts against the jig.

Next, the top side screw portion 132 of the fixing member 13 is inserted into the through hole HR1 from under the main body member 11. The tip portion of a hexagonal wrench is inserted into a hexagonal hole which is formed in the bottom surface of the bottom side screw portion 133 of the fixing member 13, the hexagonal wrench is rotated around the center axis of the fixing member 13, and the top side screw portion 132 of the fixing member 13 is fastened to the nut 12.

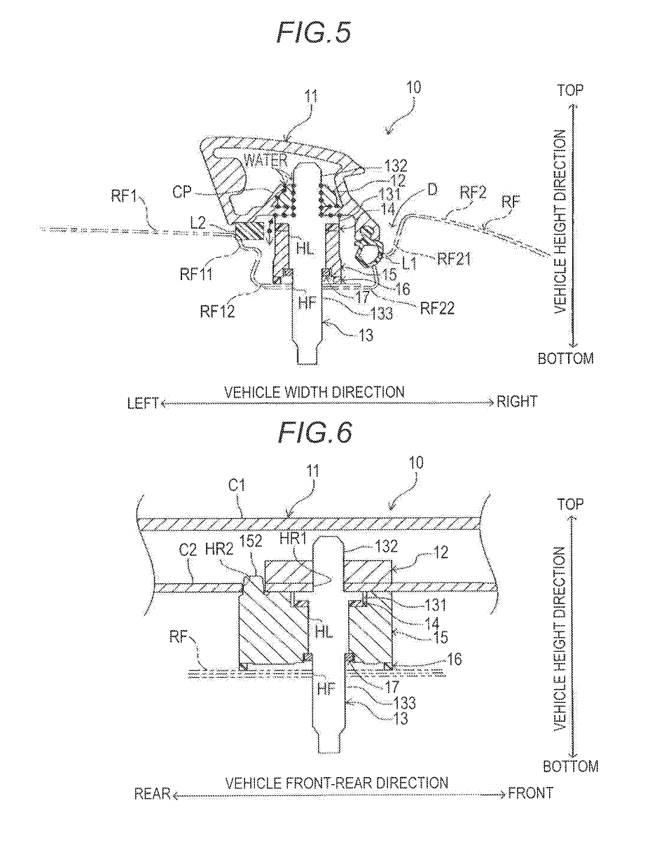

Next, the second seal member 14 is inserted into the bottom side screw portion 133 of the fixing member 13. Next, the bottom side screw portion 133 is inserted into the through hole HL of the support member 15. Next, the protruding portion 152 of the support member 15 is inserted into the through hole HR2, and the bottom surface of the bottom wall portion C2 of the main body member 11 is caused to abut against the top surface of the support member 15. The push nut 17 is fitted into the bottom side screw portion 133. The support member 15 is temporarily fixed to the fixing member 13 by fitting the tab portions 171 of the push nut 17 into the screw groove of the bottom side screw portion 133. The first seal member 16 is adhered, in advance, to the bottom surface of the support member 15. In this state, the push nut 17 is stored inside the recessed portion 153. In this state, the flange portion 131 and the second seal member 14 are stored in the recessed portion 151. The second seal member 14 is interposed between the flange portion 131 and the recessed portion 151 (refer to FIGS. 5 and 6).

Next, the bottom side screw portion 133 is inserted into the through hole HF which is formed in the groove portion D. The nut NT is fastened to the bottom side screw portion 133 from under the groove portion D. In this state, the second seal member 14 is caused to abut against the bottom surface of the flange portion 131 and the base surface of the recessed portion 151 and is slightly compressed. In other words, the second seal member 14 adheres to the flange portion 131 and the recessed portion 151. The first seal member 16 abuts against the base surface of the groove portion D and is slightly compressed. In other words, the first seal member 16 adheres to the support member 15 and the groove portion D. The top surface of the support member 15 abuts against the bottom surface of the bottom wall portion C2 of the main body member 11. The bottom surface of the support member 15 (the bottom surface of the protruding portion 154) abuts against the base surface of the groove portion D. The lip member L1 and the lip member L2 abut against the top end portions of the groove portion D (the top end portions of the level difference portions RF11 and RF21), respectively.

In the roof rail device 10 described above, since the nut 12 and the top side screw portion 132 are not coated with an adhesive, as illustrated by the dotted line in FIG. 5, water may pass along the fitting portions of both screw portions and enter the through hole HR1. Since no seal member is provided on the bottom surface of the nut 12, the water which enters the gap of the abutting portion between the nut 12 and the bottom wall portion C2 may enter the through hole HR1. The water which enters the through hole HR1 passes along the flange portion 131 and enters the recessed portion 151. The second seal member 14 is adhered to the bottom surface of the flange portion 131 and the base surface of the recessed portion 151. Therefore, the water which enters the recessed portion 151 is suppressed from entering the through hole HL. Therefore, the water which enters the recessed portion 151 is drained from the opening portion OP of the recessed portion 151 to the outside of the support member 15. Accordingly, the entrance of water into the roof is suppressed. The opening portion OP corresponds to the drainage port disclosed here.

In the embodiment, since no seal member is provided on the bottom surface of the nut 12, it is possible to cut the part cost and the manufacturing cost of the nut 12 in comparison with the related art. In the process of inserting the nut 12 into the groove portion CG, it is possible to reduce the friction between the nut 12 and the groove portion CG in comparison with a case in which the seal member is provided on the bottom surface of the nut 12. Therefore, it is possible to improve the workability.

In the embodiment disclosed here, the configuration is not limited to the embodiment described above, and various modifications are possible within the scope of the object disclosed here.

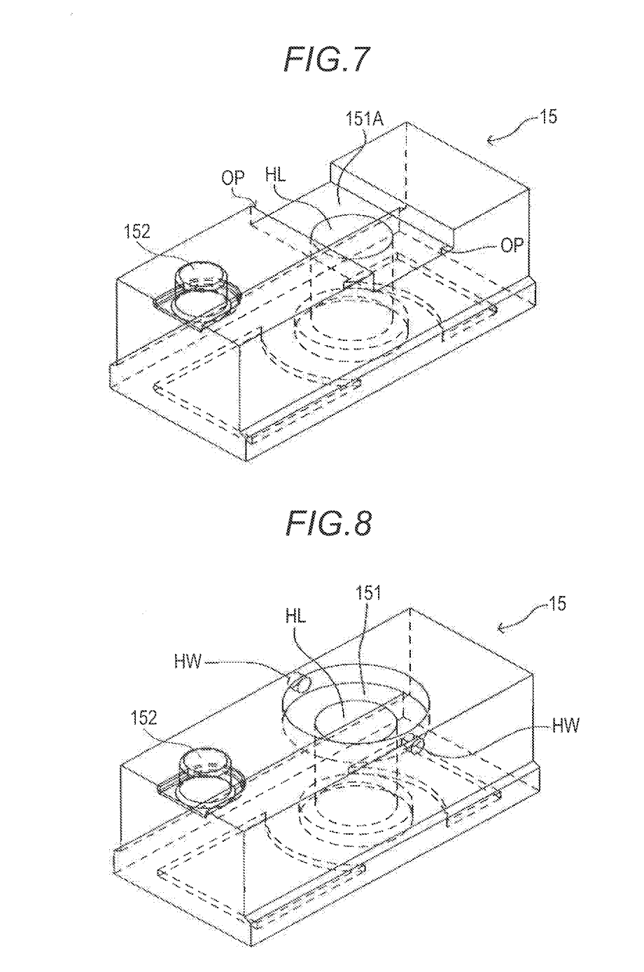

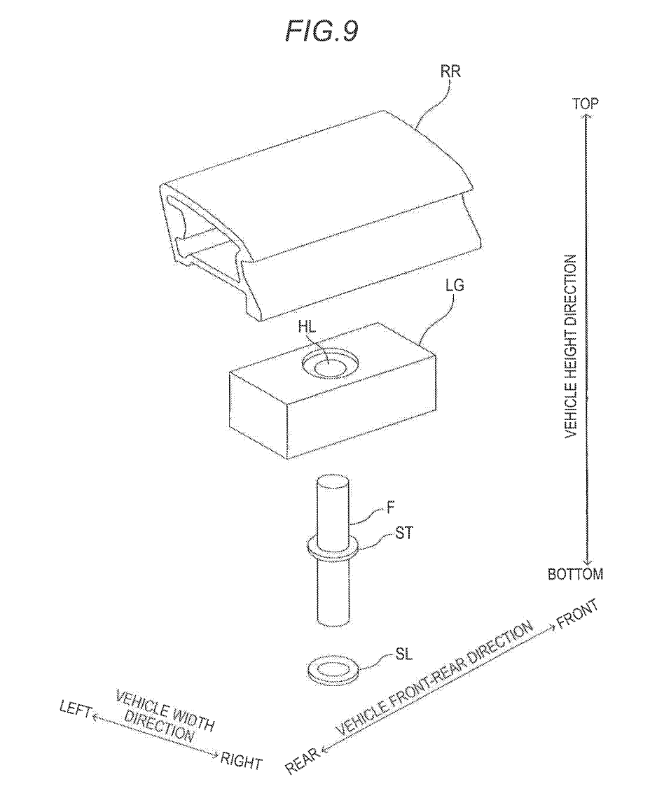

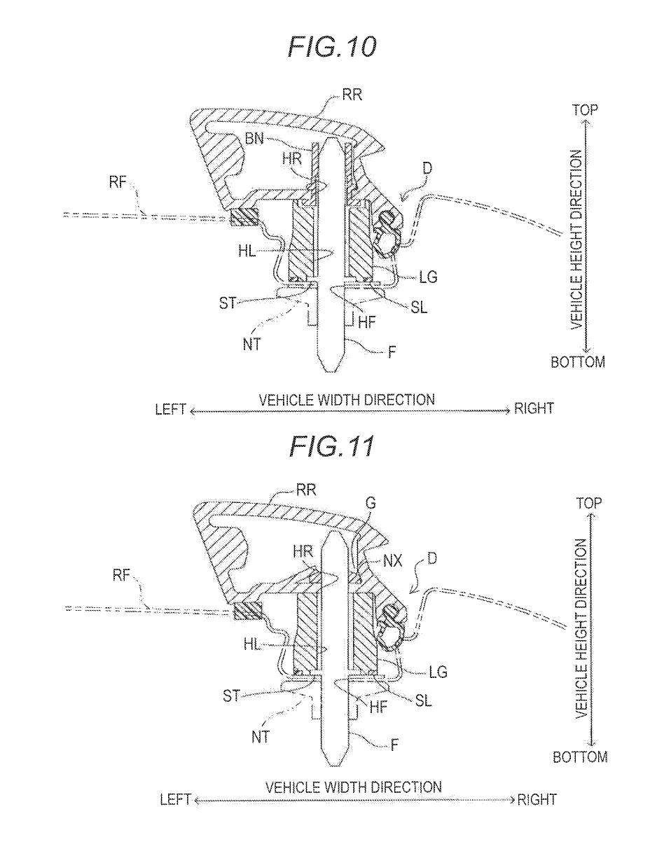

For example, the shape of the recessed portion 151 is not limited to the embodiment described above. For example, as illustrated in FIG. 7, a groove portion 151A which extends in the vehicle width direction may be formed instead of the recessed portion 151. For example, as illustrated in FIG. 8, a through hole HW which penetrates from the side surface portion of the recessed portion 151 to the side surface portion of the support member 15 may be formed. In this case, the water which enters the recessed portion 151 passes through the through hole HW and is drained to the outside of the support member 15. In other words, the through hole HW corresponds to the drainage port disclosed here.

For example, the recessed portion 151 may be omitted. In this case, the outer diameter of the flange portion 131 may be enlarged such that the flange portion 131 protrudes to the outside of the support member 15. Accordingly, the water which enters the through hole HR1 passes along the top surface of the flange portion 131 and is drained to the outside of the support member 15. Accordingly, the entrance of water into the roof is suppressed.

The bottom wall portion C2 of the main body member 11 may be formed to be thicker than in the embodiment described above, and a screw groove may be formed in the circumferential surface of the through hole HR. The top side screw portion 132 of the fixing member 13 may be fastened to the screw groove. Accordingly, it is possible to omit the nut 12.

A feature of an aspect of this disclosure resides in that a roof rail device (10) includes a main body member (11) which extends along a roof panel of a vehicle, a support member (15) which is formed in a solid shape and supports the main body member by being interposed between the main body member and the roof panel, a fixing member (13) which fixes the main body member and the support member to the roof panel, and a first seal member (16) which is provided between the support member and the roof panel and adheres to the support member and the roof panel, in which the support member includes a through hole (HL) which penetrates the support member in a vehicle height direction, in which the fixing member is provided with a flange portion (131) which is perpendicular to the vehicle height direction, in which a top side screw portion (132) which is fastened to the main body member is formed in a top surface of the flange portion, in which a bottom side screw portion (133) which is fastened to the roof panel is formed in a bottom surface of the flange portion, and in which the top side screw portion is fastened to the main body member, the bottom side screw portion is inserted into the through hole of the support member from above the support member, and the bottom side screw portion is fastened to the roof panel in a state in which the flange portion is interposed between the main body member and the support member.

In this case, the support member may include a recessed portion (151) which stores the flange portion, and the support member may include a drainage port (OP, HW) which communicates from the recessed portion to a side surface portion of the support member, and which drains water which enters the recessed portion from the recessed portion.

Also, in this case, the roof rail device may further include a second seal member which adheres to a bottom surface of the flange portion and the recessed portion.

In the roof rail device configured as described above, even if water enters the through hole which is formed in the main body member and into which the top end portion of the fixing member is inserted, the entrance of water into the through hole of the fixing member is suppressed by the flange portion which is positioned under the top end portion of the fixing member. In other words, the water flows along the top surface of the flange portion and is drained to the outside of the support member. Accordingly, the entrance of water into the roof is suppressed. Therefore, it is not necessary to provide means for preventing the entrance of water (an adhesive, a seal member, or the like) to the top end portion of the fixing member and to a fastening member (for example, a nut) to which the corresponding portion is fastened. Accordingly, it is possible to reduce part costs in comparison to a roof rail device of the related art, and it is possible to improve workability.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed:

1. A roof rail device comprising:
a main body member which extends along a roof panel of a vehicle;
a support member which is formed in a solid shape and supports the main body member by being interposed between the main body member and the roof panel;
a fixing member which fixes the main body member and the support member to the roof panel; and
a first seal member which is provided between the support member and the roof panel and adheres to the support member and the roof panel,
wherein the support member includes a through hole which penetrates the support member in a vehicle height direction,
wherein the fixing member is provided with a flange portion which is perpendicular to the vehicle height direction,
wherein a top side screw portion which is fastened to the main body member is formed in a top surface of the flange portion,
wherein a bottom side screw portion which is fastened to the roof panel is formed in a bottom surface of the flange portion, and
wherein the top side screw portion is fastened to the main body member, the bottom side screw portion is inserted into the through hole of the support member from above the support member, and the bottom side screw portion is fastened to the roof panel in a state in which the flange portion is interposed between the main body member and the support member.

2. The roof rail device according to claim 1,
wherein the support member includes a recessed portion which stores the flange portion, and
wherein the support member includes a drainage port which communicates from the recessed portion to a side surface portion of the support member, and which drains water which enters the recessed portion from the recessed portion.

3. The roof rail device according to claim 2, further comprising:
a second seal member which adheres to a bottom surface of the flange portion and the recessed portion.
